(19) United States
(12) Patent Application Publication
(10) Pub. No.: US 2025/0324333 A1
(43) Pub. Date: Oct. 16, 2025

(54) APPARATUS, METHOD, AND COMPUTER PROGRAM

(71) Applicant: Nokia Technologies Oy, Espoo (FI)

(72) Inventors: Mads LAURIDSEN, Aalborg (DK); Srinivasan SELVAGANAPATHY, Bangalore (IN); Jeroen WIGARD, Aalborg (DK); Xiang XU, Beijing (CN)

(21) Appl. No.: 18/867,579

(22) PCT Filed: Aug. 1, 2022
(86) PCT No.: PCT/CN2022/109530

§ 371 Date: Nov. 20, 2024

(51) Int. Cl. H04W 36/08; H04W 12/037; H04W 36/32

(52) U.S. Cl. CPC H04W 36/083; H04W 12/037; H04W 36/322

(57) ABSTRACT

There is provided a method, computer program and apparatus for causing a non-geostationary first access node to: determine to suspend a radio resource control connection between the non-geostationary first access node and a user equipment, wherein the radio resource control connection is defined by a user context; and provide the user context to a first proxy node with an indication that the user context is to be stored for retrieval by a non-geostationary second access node.

### FIELD OF THE DISCLOSURE

The examples described herein generally relate to apparatus, methods, and computer programs, and more particularly (but not exclusively) to apparatus, methods and computer programs for network apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided an apparatus for a non-geostationary first access node, the apparatus comprising means for performing: determining to suspend a radio resource control connection between the non-geostationary first access node and a user equipment, wherein the radio resource control connection is defined by a user context; and providing the user context to a first proxy node with an indication that the user context is to be stored for retrieval by a non-geostationary second access node.

The means for determining may comprise means for performing: determining that the user equipment is likely to receive feedback to previously transmitted uplink data within a first time period and that the non-geostationary first access node will not be providing a service connectivity to the user equipment for at least part of the first time period; and/or determining that the user equipment has uplink data to transmit during a second time period and that the non-geostationary first access node will not be providing a service connectivity to the user equipment for at least part of the second time period; and/or determining, based on a traffic pattern associated with the user equipment, that the user equipment is likely to transmit and/or receive data during a third predetermined time period and that the non-geostationary first access node will not be providing a service connectivity to the user equipment for at least part of the third time period.

The apparatus may comprise means for performing: identifying the non-geostationary second access node and/or an apparatus comprising the non-geostationary second access node; and providing an indication of the non-geostationary second access node and/or the apparatus comprising the non-geostationary second access node to the first proxy node.

The means for identifying the non-geostationary second access node and/or the apparatus comprising the non-geostationary second access node may comprise means for identifying the non-geostationary second access node and/or the apparatus comprising the non-geostationary second access node based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a second aspect, there is provided an apparatus for a first proxy node, the apparatus comprising means for performing: receiving, from a non-geostationary first access node, a user context that defines a radio resource control connection between the non-geostationary first access node and a user equipment, and an indication that the user context is to be provided to a non-geostationary second access node; and causing the user context to be provided to the non-geostationary second access node.

The means for causing the user context to be provided to a non-geostationary second access node may comprise means for performing: providing the user context to a second proxy node with an indication that the user context is to be provided to the non-geostationary second access node.

The means for causing the user context to be provided to a non-geostationary second access node may comprise means for performing: providing the user context directly to the non-geostationary second access node.

The apparatus may comprise means for performing receiving an identifier of the non-geostationary second access node from the non-geostationary first access node.

The apparatus may comprise means for performing receiving the identifier of the non-geostationary second access node as part of receiving a set of identifiers identifying respective access nodes.

The apparatus may comprise means for performing providing the user context to at least two of said respective access nodes.

The apparatus may comprise means for performing providing the user context to all of said respective access nodes.

The apparatus may comprise means for performing identifying the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The means for causing the user context to be provided to the non-geostationary second access node may comprise means for causing the user context to be provided to the non-geostationary second access node with an indication of at a time at which the user context is to be deleted by the non-geostationary second access node.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a third aspect, there is provided an apparatus for a non-geostationary second access node, the apparatus comprising means for performing: receiving, from a first and/or second proxy node, a user context that defines a radio resource control connection between a non-geostationary first access node and a user equipment; and resuming a radio resource control connection procedure between the user equipment and the non-geostationary second access node using the user context.

The means for resuming a radio resource control connection procedure may comprise means for performing: receiving, from the first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The means for resuming a radio resource control connection procedure may comprise means for performing said resuming in response to: signalling, to the user equipment, a trigger in a paging signal for causing the user equipment to initiate the resume radio resource control procedure.

The means for resuming a radio resource control connection procedure may comprise means for performing said resuming in response to: receiving, from a user equipment an instruction to initiate the resume radio resource control procedure when the user context defines that the user equipment is configured to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a fourth aspect, there is provided an apparatus for a user equipment, the apparatus comprising means for performing: establishing a radio resource control connection with a non-geostationary first access node, the radio resource control connection being defined by a user context; suspending the radio resource control connection using a suspend radio resource control connection procedure; resuming the radio resource control connection with a non-geostationary second access node using the user context.

The means for resuming the radio resource control connection may comprise means for performing: receiving, from a first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The means for resuming a radio resource control connection procedure may comprise means for performing said resuming in response to: determining, from the user context that the user equipment is configured to initiate the resume radio resource control procedure.

The means for resuming a radio resource control connection procedure may comprise means for performing: retrieving, from the user context, an indication of a count value; using the count value to generate a plurality of keys for encrypting communications between the non-geostationary second access node and the user equipment; and using the plurality of keys for encrypting communications between the non-geostationary second access node and the user equipment.

The means for resuming a radio resource control connection procedure may comprise means for performing said resuming in response to: receiving, from the non-geostationary second access node, a trigger in a paging signal for causing the user equipment to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a fifth aspect, there is provided an apparatus for a non-geostationary first access node, the apparatus comprising: at least one processor; and at least one memory comprising code that, when executed by the at least one processor causes the apparatus to perform: determining to suspend a radio resource control connection between the non-geostationary first access node and a user equipment, wherein the radio resource control connection is defined by a user context; and providing the user context to a first proxy node with an indication that the user context is to be stored for retrieval by a non-geostationary second access node.

The determining may comprise performing: determining that the user equipment is likely to receive feedback to previously transmitted uplink data within a first time period and that the non-geostationary first access node will not be providing a service connectivity to the user equipment for at least part of the first time period; and/or determining that the user equipment has uplink data to transmit during a second time period and that the non-geostationary first access node will not be providing a service connectivity to the user equipment for at least part of the second time period; and/or determining, based on a traffic pattern associated with the user equipment, that the user equipment is likely to transmit and/or receive data during a third predetermined time period and that the non-geostationary first access node will not be providing a service connectivity to the user equipment for at least part of the third time period.

The apparatus may comprise performing: identifying the non-geostationary second access node and/or an apparatus comprising the non-geostationary second access node; and providing an indication of the non-geostationary second access node and/or the apparatus comprising the non-geostationary second access node to the first proxy node.

The identifying the non-geostationary second access node and/or the apparatus comprising the non-geostationary second access node may comprise identifying the non-geostationary second access node and/or the apparatus comprising the non-geostationary second access node based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a sixth aspect, there is provided an apparatus for a first proxy node, the apparatus comprising: at least one processor; and at least one memory comprising code that, when executed by the at least one processor causes the apparatus to perform: receiving, from a non-geostationary first access node, a user context that defines a radio resource control connection between the non-geostationary first access node and a user equipment, and an indication that the user context is to be provided to a non-geostationary second access node; and causing the user context to be provided to the non-geostationary second access node.

The causing the user context to be provided to a non-geostationary second access node may comprise performing: providing the user context to a second proxy node with an indication that the user context is to be provided to the non-geostationary second access node.

The causing the user context to be provided to a non-geostationary second access node may comprise performing: providing the user context directly to the non-geostationary second access node.

The apparatus may comprise performing receiving an identifier of the non-geostationary second access node from the non-geostationary first access node.

The apparatus may comprise performing receiving the identifier of the non-geostationary second access node as part of receiving a set of identifiers identifying respective access nodes.

The apparatus may comprise performing providing the user context to at least two of said respective access nodes.

The apparatus may comprise performing providing the user context to all of said respective access nodes.

The apparatus may comprise performing identifying the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at a time at which the user context is to be deleted by the non-geostationary second access node.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a seventh aspect, there is provided an apparatus for a non-geostationary second access node, the apparatus comprising: at least one processor; and at least one memory comprising code that, when executed by the at least one processor causes the apparatus to perform: receiving, from a first and/or second proxy node, a user context that defines a radio resource control connection between a non-geostationary first access node and a user equipment; and resuming a radio resource control connection procedure between the user equipment and the non-geostationary second access node using the user context.

The resuming a radio resource control connection procedure may comprise performing: receiving, from the first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: signalling, to the user equipment, a trigger in a paging signal for causing the user equipment to initiate the resume radio resource control procedure.

The resuming a radio resource control connection procedure may comprise performing said resuming in response to: receiving, from a user equipment an instruction to initiate the resume radio resource control procedure when the user context defines that the user equipment is configured to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to an eighth aspect, there is provided an apparatus for a user equipment, the apparatus comprising: at least one processor; and at least one memory comprising code that, when executed by the at least one processor causes the apparatus to perform: establishing a radio resource control connection with a non-geostationary first access node, the radio resource control connection being defined by a user context; suspending the radio resource control connection using a suspend radio resource control connection procedure; resuming the radio resource control connection with a non-geostationary second access node using the user context.

The resuming the radio resource control connection may comprise performing: receiving, from a first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: determining, from the user context that the user equipment is configured to initiate the resume radio resource control procedure.

The resuming a radio resource control connection procedure may comprise performing: retrieving, from the user context, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: receiving, from the non-geostationary second access node, a trigger in a paging signal for causing the user equipment to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a ninth aspect, there is provided a method for an apparatus for a non-geostationary first access node, the method comprising: determining to suspend a radio resource control connection between the non-geostationary first access node and a user equipment, wherein the radio resource control connection is defined by a user context; and providing the user context to a first proxy node with an indication that the user context is to be stored for retrieval by a non-geostationary second access node.

The determining may comprise: determining that the user equipment is likely to receive feedback to previously transmitted uplink data within a first time period and that the non-geostationary first access node will not be providing a service connectivity to the user equipment for at least part of the first time period; and/or determining that the user equipment has uplink data to transmit during a second time period and that the non-geostationary first access node will not be providing a service connectivity to the user equipment for at least part of the second time period; and/or determining, based on a traffic pattern associated with the user equipment, that the user equipment is likely to transmit and/or receive data during a third predetermined time period and that the non-geostationary first access node will not be providing a service connectivity to the user equipment for at least part of the third time period.

The method may comprise: identifying the non-geostationary second access node and/or an apparatus comprising the non-geostationary second access node; and providing an indication of the non-geostationary second access node and/or the apparatus comprising the non-geostationary second access node to the first proxy node.

The identifying the non-geostationary second access node and/or the apparatus comprising the non-geostationary second access node may comprise identifying the non-geostationary second access node and/or the apparatus comprising the non-geostationary second access node based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a tenth aspect, there is provided a method for an apparatus for a first proxy node, the method comprising: receiving, from a non-geostationary first access node, a user context that defines a radio resource control connection between the non-geostationary first access node and a user equipment, and an indication that the user context is to be provided to a non-geostationary second access node; and causing the user context to be provided to the non-geostationary second access node.

The causing the user context to be provided to a non-geostationary second access node may comprise: providing the user context to a second proxy node with an indication that the user context is to be provided to the non-geostationary second access node.

The causing the user context to be provided to a non-geostationary second access node may comprise performing: providing the user context directly to the non-geostationary second access node.

The method may comprise: receiving an identifier of the non-geostationary second access node from the non-geostationary first access node.

The method may comprise: receiving the identifier of the non-geostationary second access node as part of receiving a set of identifiers identifying respective access nodes.

The method may comprise: providing the user context to at least two of said respective access nodes.

The method may comprise: providing the user context to all of said respective access nodes.

The method may comprise: identifying the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at a time at which the user context is to be deleted by the non-geostationary second access node.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to an eleventh aspect, there is provided a method for an apparatus for a non-geostationary second access node, the method comprising: receiving, from a first and/or second proxy node, a user context that defines a radio resource control connection between a non-geostationary first access node and a user equipment; and resuming a radio resource control connection procedure between the user equipment and the non-geostationary second access node using the user context.

The resuming a radio resource control connection procedure may comprise: receiving, from the first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: signalling, to the user equipment, a trigger in a paging signal for causing the user equipment to initiate the resume radio resource control procedure.

The resuming a radio resource control connection procedure may comprise performing said resuming in response to: receiving, from a user equipment an instruction to initiate the resume radio resource control procedure when the user context defines that the user equipment is configured to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a twelfth aspect, there is provided a method for an apparatus for a user equipment, the method comprising: establishing a radio resource control connection with a non-geostationary first access node, the radio resource control connection being defined by a user context; suspending the radio resource control connection using a suspend radio resource control connection procedure; resuming the radio resource control connection with a non-geostationary second access node using the user context.

The resuming the radio resource control connection may comprise performing: receiving, from a first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: determining, from the user context that the user equipment is configured to initiate the resume radio resource control procedure.

The resuming a radio resource control connection procedure may comprise: retrieving, from the user context, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: receiving, from the non-geostationary second access node, a trigger in a paging signal for causing the user equipment to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a thirteenth aspect, there is provided an apparatus for a non-geostationary first access node, the apparatus comprising: determining circuitry for determining to suspend a radio resource control connection between the non-geostationary first access node and a user equipment, wherein the radio resource control connection is defined by a user context; and providing circuitry for providing the user context to a first proxy node with an indication that the user context is to be stored for retrieval by a non-geostationary second access node.

The determining circuitry for determining may comprise performing circuitry for performing: determining that the user equipment is likely to receive feedback to previously transmitted uplink data within a first time period and that the non-geostationary first access node will not be providing a service connectivity to the user equipment for at least part of the first time period; and/or determining that the user equipment has uplink data to transmit during a second time period and that the non-geostationary first access node will not be providing a service connectivity to the user equipment for at least part of the second time period; and/or determining, based on a traffic pattern associated with the user equipment, that the user equipment is likely to transmit and/or receive data during a third predetermined time period and that the non-geostationary first access node will not be providing a service connectivity to the user equipment for at least part of the third time period.

The apparatus may comprise: identifying circuitry for identifying the non-geostationary second access node and/or an apparatus comprising the non-geostationary second access node; and providing circuitry for providing an indication of the non-geostationary second access node and/or the apparatus comprising the non-geostationary second access node to the first proxy node.

The identifying circuitry for identifying the non-geostationary second access node and/or the apparatus comprising the non-geostationary second access node may comprise identifying circuitry for identifying the non-geostationary second access node and/or the apparatus comprising the non-geostationary second access node based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a fourteenth aspect, there is provided an apparatus for a first proxy node, the apparatus comprising: receiving circuitry for receiving, from a non-geostationary first access node, a user context that defines a radio resource control connection between the non-geostationary first access node and a user equipment, and an indication that the user context is to be provided to a non-geostationary second access node; and causing circuitry for causing the user context to be provided to the non-geostationary second access node.

The causing circuitry for causing the user context to be provided to a non-geostationary second access node may comprise: providing circuitry for providing the user context to a second proxy node with an indication that the user context is to be provided to the non-geostationary second access node.

The causing circuitry for causing the user context to be provided to a non-geostationary second access node may comprise: providing circuitry for providing the user context directly to the non-geostationary second access node.

The apparatus may comprise receiving circuitry for receiving an identifier of the non-geostationary second access node from the non-geostationary first access node.

The apparatus may comprise receiving circuitry for receiving the identifier of the non-geostationary second access node as part of receiving a set of identifiers identifying respective access nodes.

The apparatus may comprise providing circuitry for providing the user context to at least two of said respective access nodes.

The apparatus may comprise providing circuitry for providing the user context to all of said respective access nodes.

The apparatus may comprise identifying circuitry for identifying the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The causing circuitry for causing the user context to be provided to the non-geostationary second access node may comprise causing circuitry for causing the user context to be provided to the non-geostationary second access node with an indication of at a time at which the user context is to be deleted by the non-geostationary second access node.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a fifteenth aspect, there is provided an apparatus for a non-geostationary second access node, the apparatus comprising: receiving circuitry for receiving, from a first and/or second proxy node, a user context that defines a radio resource control connection between a non-geostationary first access node and a user equipment; and resuming circuitry for resuming a radio resource control connection procedure between the user equipment and the non-geostationary second access node using the user context.

The resuming circuitry for resuming a radio resource control connection procedure may comprise: receiving circuitry for receiving, from the first and/or second proxy node, an indication of a count value; using circuitry for using the count value to generate a plurality of keys for encrypting communications between the non-geostationary second access node and the user equipment; and using circuitry for using the plurality of keys for encrypting communications between the non-geostationary second access node and the user equipment.

The resuming circuitry for resuming a radio resource control connection procedure may comprise performing circuitry for performing said resuming in response to: signalling, to the user equipment, a trigger in a paging signal for causing the user equipment to initiate the resume radio resource control procedure.

The resuming circuitry for resuming a radio resource control connection procedure may comprise performing circuitry for performing said resuming in response to: receiving, from a user equipment an instruction to initiate the resume radio resource control procedure when the user context defines that the user equipment is configured to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a sixteenth aspect, there is provided an apparatus for a user equipment, the apparatus comprising: establishing circuitry for establishing a radio resource control connection with a non-geostationary first access node, the radio resource control connection being defined by a user context; suspending circuitry for suspending the radio resource control connection using a suspend radio resource control connection procedure; resuming circuitry for resuming the radio resource control connection with a non-geostationary second access node using the user context.

The resuming circuitry for resuming the radio resource control connection may comprise: receiving circuitry for receiving, from a first and/or second proxy node, an indication of a count value; using the count value to generate a plurality of keys for encrypting communications between the non-geostationary second access node and the user equipment; and using circuitry for using the plurality of keys for encrypting communications between the non-geostationary second access node and the user equipment.

The resuming circuitry for resuming a radio resource control connection procedure may comprise performing circuitry for performing said resuming in response to: determining, from the user context that the user equipment is configured to initiate the resume radio resource control procedure.

The resuming circuitry for resuming a radio resource control connection procedure may comprise means for performing: retrieving, from the user context, an indication of a count value; using circuitry for using the count value to generate a plurality of keys for encrypting communications between the non-geostationary second access node and the user equipment; and using the plurality of keys for encrypting communications between the non-geostationary second access node and the user equipment.

The resuming circuitry for resuming a radio resource control connection procedure may comprise performing circuitry for performing said resuming in response to: receiving, from the non-geostationary second access node, a trigger in a paging signal for causing the user equipment to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a seventeenth aspect, there is provided non-transitory computer readable medium comprising program instructions for causing an apparatus for a non-geostationary first access node to perform at least the following: determining to suspend a radio resource control connection between the non-geostationary first access node and a user equipment, wherein the radio resource control connection is defined by a user context; and providing the user context to a first proxy node with an indication that the user context is to be stored for retrieval by a non-geostationary second access node.

The determining may comprise performing: determining that the user equipment is likely to receive feedback to previously transmitted uplink data within a first time period and that the non-geostationary first access node will not be providing a service connectivity to the user equipment for at least part of the first time period; and/or determining that the user equipment has uplink data to transmit during a second time period and that the non-geostationary first access node will not be providing a service connectivity to the user equipment for at least part of the second time period; and/or determining, based on a traffic pattern associated with the user equipment, that the user equipment is likely to transmit and/or receive data during a third predetermined time period and that the non-geostationary first access node will not be providing a service connectivity to the user equipment for at least part of the third time period.

The apparatus may comprise performing: identifying the non-geostationary second access node and/or an apparatus comprising the non-geostationary second access node; and providing an indication of the non-geostationary second access node and/or the apparatus comprising the non-geostationary second access node to the first proxy node.

The identifying the non-geostationary second access node and/or the apparatus comprising the non-geostationary second access node may comprise identifying the non-geostationary second access node and/or the apparatus comprising the non-geostationary second access node based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to an eighteenth aspect, there is provided non-transitory computer readable medium comprising program instructions for causing an apparatus for a proxy node: receiving, from a non-geostationary first access node, a user context that defines a radio resource control connection between the non-geostationary first access node and a user equipment, and an indication that the user context is to be provided to a non-geostationary second access node; and causing the user context to be provided to the non-geostationary second access node.

The causing the user context to be provided to a non-geostationary second access node may comprise performing: providing the user context to a second proxy node with an indication that the user context is to be provided to the non-geostationary second access node.

The causing the user context to be provided to a non-geostationary second access node may comprise performing: providing the user context directly to the non-geostationary second access node.

The apparatus may comprise performing receiving an identifier of the non-geostationary second access node from the non-geostationary first access node.

The apparatus may comprise performing receiving the identifier of the non-geostationary second access node as part of receiving a set of identifiers identifying respective access nodes.

The apparatus may comprise performing providing the user context to at least two of said respective access nodes.

The apparatus may comprise performing providing the user context to all of said respective access nodes.

The apparatus may comprise performing identifying the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at a time at which the user context is to be deleted by the non-geostationary second access node.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a nineteenth aspect, there is provided non-transitory computer readable medium comprising program instructions for causing an apparatus for a non-geostationary second access node to perform at least the following: receiving, from a first and/or second proxy node, a user context that defines a radio resource control connection between a non-geostationary first access node and a user equipment; and resuming a radio resource control connection procedure between the user equipment and the non-geostationary second access node using the user context.

The resuming a radio resource control connection procedure may comprise performing: receiving, from the first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: signalling, to the user equipment, a trigger in a paging signal for causing the user equipment to initiate the resume radio resource control procedure.

The resuming a radio resource control connection procedure may comprise performing said resuming in response to: receiving, from a user equipment an instruction to initiate the resume radio resource control procedure when the user context defines that the user equipment is configured to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a twentieth aspect, there is provided non-transitory computer readable medium comprising program instructions for causing an apparatus for a user equipment to perform at least the following: establishing a radio resource control connection with a non-geostationary first access node, the radio resource control connection being defined by a user context; suspending the radio resource control connection using a suspend radio resource control connection procedure; resuming the radio resource control connection with a non-geostationary second access node using the user context.

The resuming the radio resource control connection may comprise performing: receiving, from a first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: determining, from the user context that the user equipment is configured to initiate the resume radio resource control procedure.

The resuming a radio resource control connection procedure may comprise performing: retrieving, from the user context, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: receiving, from the non-geostationary second access node, a trigger in a paging signal for causing the user equipment to initiate the resume radio resource control procedure.

The first and/or second proxy node may be at least one of: a ground-based gateway to a core network, a database located in a core network, and/or a Mobility Management Entity.

The user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

According to a twenty first aspect, there is provided a computer program product stored on a medium that may cause an apparatus to perform any method as described herein.

According to a twenty second aspect, there is provided an electronic device that may comprise apparatus as described herein.

According to a twenty third aspect, there is provided a chipset that may comprise an apparatus as described herein.

### BRIEF DESCRIPTION OF FIGURES

Some examples, will now be described, merely by way of illustration only, with reference to the accompanying drawings in which:

FIGS. 1A and 1B show a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a network;

FIG. 6 illustrates signalling between apparatus;

FIG. 7 illustrates an example scenario between apparatus described herein;

FIG. 8 illustrates example signalling between apparatus described herein; and

FIGS. 9 to 12 are flow charts illustrating example operations performed by apparatus described herein.

### DETAILED DESCRIPTION

In the following description of examples, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals).

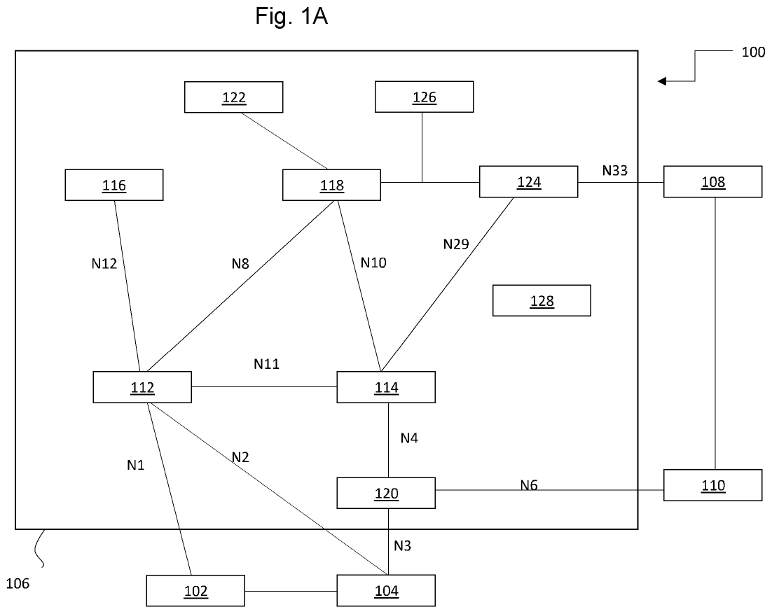

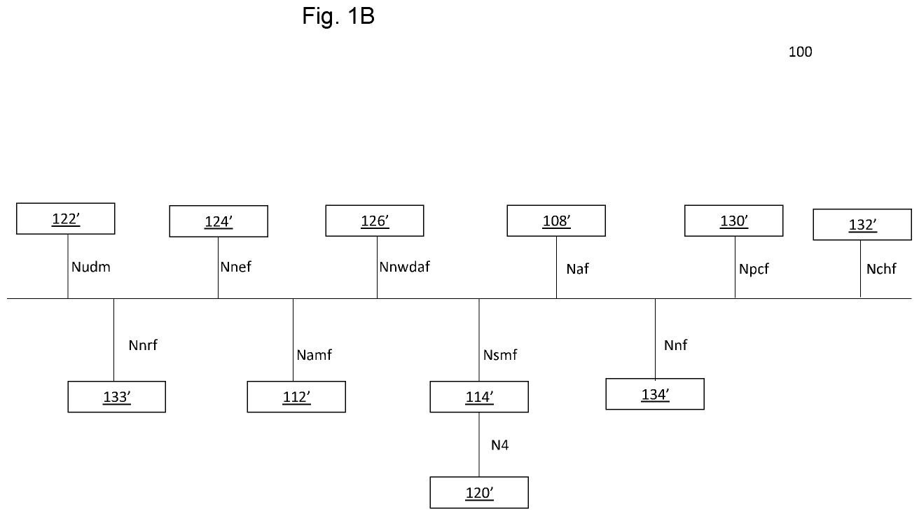

Before describing in detail the examples, certain general principles of a 5G wireless communication system are briefly explained with reference to FIGS. 1A and 1B.

FIG. 1A shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

FIG. 1B shows a schematic representations of a 5GC represented in current 3GPP specifications. It is understood that this architecture is intended to illustrate potential components that may be comprised in a core network, and the presently described principles are not limited to core networks comprising only the described components.

FIG. 1B shows a 5GC 106′ comprising a UPF 120′ connected to an SMF 114′ over an N4 interface. The SMF 114′ is connected to each of a UDM 122′, an NEF 124′, an NWDAF 126′, an AF 108′, a Policy Control Function (PCF) 130′, an AMF 112′, and a Charging function 132′ over an interconnect medium that also connects these network functions to each other. The 5G core 106′ further comprises a network repository function (NRF) 133′ and a network function 134′ that connect to the interconnect medium.

3GPP refers to a group of organizations that develop and release different standardized communication protocols. 3GPP develops and publishes documents pertaining to a system of “Releases” (e.g., Release 15, Release 16, and beyond).

The following relates to non-terrestrial networks (NTN). NTN refers to networks that can providing connectivity to a core network through space-borne vehicles (such as satellites) and/or through airborne platforms. These networks may thus provide radio connectivity between a User Equipment (UE) on the ground and the vehicle/platform.

NTN have been defined for New Radio and Narrow Band (NB)-Internet of Things (IoT)/enhanced Machine Type Communications (eMTC) in 3GPP's Release 17. As part of preparations for Release 18, companies submitted further proposals for NTN in a 3GPP framework.

One potential operation/use case relates to a store and forward operation for IoT NTN.

Store-and-forward (S&F) is a new feature that will allow a satellite to provide service to IoT NTN devices even in periods/areas when/where the satellite is not connected to a Gateway on the ground for connecting the satellite to the core network. An eNB-on-board architecture is assumed such that the satellite is assumed to comprise radio access node (RAN) functionality such that the UE treats the satellite as a RAN node. There is a feeder link that is a link connecting the satellite (comprising an eNB) and the Gateway (which is then connected to the core network). There is also a service link that is a link connecting the satellite (eNB) and the UE. Non-simultaneous operation of the service link and the feeder link is also assumed to be supported. Messages received by the satellite during the time period during which the satellite is unconnected to a land-based gateway may be stored on board the satellite until there is a line of sight with the gateway. To help support this, decoupled signalling procedures may be included in the 3GPP framework (e.g., support for signalling between a UE and a satellite with an onboard Radio Access Network (RAN) node, and, independent to this, support for signalling between the satellite with an onboard RAN node and a gateway to the core network entity. It would also be useful to support dynamic attachment between the gateway and the satellite.

Dynamic attachment refers to a dynamic connection setup and/or dynamic connection release. In the present example, dynamic attachment provides support for the feeder link between the eNB on the satellite and a core network connection point (e.g., a non-terrestrial network gateway) being unavailable at times. In contrast, terrestrial-based access points always have access to a core network. It is understood that techniques described in the following in relation to satellites comprising an access point may be applied to any access point to a core network that has intermittent access to the core network.

The store and forward operation builds on the Release 17 concept of discontinuous coverage scenario in which the UE only occasionally and temporarily has coverage from a satellite. The discontinuous coverage scenario is expanded by the store and forward operation to also define that the satellite is not always connected with the core network.

The store and forward architecture may enable a low-cost deployment that comprises just a few satellites and a few ground stations. This means the connectivity cost per device can be further reduced at the cost of only being able to support delay tolerant data relative to current NTN architectures.

A key challenge in the store and forward deployment is how the UE can establish a secure connection with a core network when the link between the UE and the satellite and the link between the satellite and the core network are not available simultaneously.

When the connection between the UE and the core network has been previously established, it may be beneficial to retain any access stratum (AS) security and Radio Resource Control (RRC) configuration that were established during that connection (the combination of which is herein referred to as “UE context”) at both the UE-side and at the core network side.

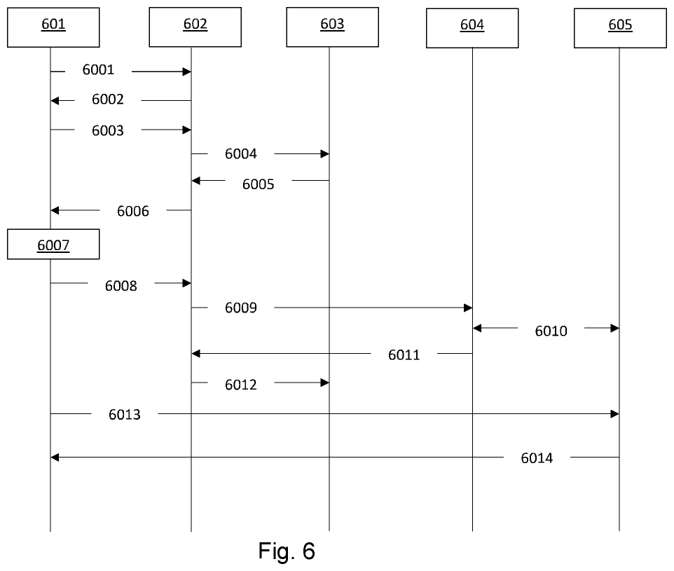

The UE may store the UE context after receiving an RRC Connection Release message in which the cause indicates the RRC is suspended. The UE context may be stored with a resume identifier (resume ID) for resuming the connection (for Evolved Packet System (EPS), the resume ID will be the Inactive-Radio Network Temporary Identifier (I-RNTI) for 5GS). The UE may subsequently indicate the resume ID to the core network when the connection is resumed at a later point in time is resumed. For example, the connection may be resumed based on mobile-originated traffic becoming available, re-establishment after a radio link failure and/or a handover failure and/or network paging. When an eNB receives the resume ID, the eNB may be caused to fetch the UE context from a past serving eNB. The resume ID may identify the previously serving eNB. This procedure is illustrated with respect to FIG. 6.

FIG. 6 illustrates signalling that may be performed between a UE 601, a new access node 602, and old access node 603, a Mobility Management Entity (MME) 604, and a Serving-gateway (S-GW) 605.

During 6001, the UE 601 signals the new access node 602. This signalling of 6001 may comprise a random access preamble for accessing the new access node 602.

During 6002, the new access node 602 responds to the signalling of 6001. The signalling of 6002 may therefore comprise a random access response.

During 6003, the UE 601 signals the new access node 602. This signalling of 6003 may comprise a request to resume a previous RRC connection. This signalling of 6003 may comprise the RRCConnectionResumeRequest service operation. The signalling of 6003 may comprise a resume ID, and/or an indication of a cause of the request of 6003. The signalling of 6003 may comprise a short Media Access Control (MAC) address for a short resume procedure.

During 6004, the new access node signals the old access node 603. This signalling of 6004 may comprise a request for the old access node 603 to provide the new access node 602 with UE context associated with the RRC connection being resumed. This signalling of 6004 may comprise a Retrieve UE context request service operation. This is because in current systems, the UE context is always stored in the last serving RAN node (e.g., an eNB) that suspends the UE's RRC connection. The retrieval procedure may be facilitated via a direct eNB-eNB (also referred to as an X2 interface) or via an NG-RAN node-NG RAN node (also referred to as an Xn interface).

During 6005, the old access node 603 responds to the signaling of 6004. This response may comprise the UE context that was requested during 6004. This signalling of 6005 may comprise a Retrieve UE Context Response service operation.

During 6006, the new access node 602 responds to the signalling of 6003. This signalling of 6006 may comprise an RRCConnectionResume service operation. This signalling of 6006 may indicate a next hop count.

During 6007, the UE may enter an RRC connected state as AD security is re-established and Signalling Radio Bearers (SRBs) and Data Radio Bearers (DRBs) are resumed using the UE context.

During 6008, the UE 601 signals the new access node 602. This signaling of 6008 may indicate that the RRC connection resume procedure has been completed. This signaling of 6008 may comprise an RRCConectionResumeComplete service operation.

During 6009, the new access node 602 may signal the MME 604. This signalling of 6009 may comprise a request to perform a path switch operation for entities looking to contact the UE 601.

During 6010, the MME 604 and the S-GW 605 may exchange signaling for modifying bearers for performing the path switch request.

During 6011, the MME 604 responds to the signalling of 6009. This signalling may be an acknowledgement of the path switch request of 6009.

During 6012, the new access node 602 signals the old access node 603. This signalling of 6012 may be a request to release the UE context previously provided in 6005. The old access node 603 may release the UE context in response to receipt of this signalling.

During 6013, the UE 601 signals uplink data to the S-GW via the new access node 602.

During 6014, the UE 601 receives downlink data from the S-GW 605 via the new access node 602.

In this example of FIG. 6, the new access node (which may, for example, be a satellite in store-and-forward use cases) is expected to retrieve the UE context from the old access node (which may be on a different satellite). However, it may not always be possible to retrieve the UE context in the store and forward operation, because the two satellites may not have direct connection and may not have core network connectivity at the same point in time. In other words, the two eNBs/access nodes being considered in store and forward operations may not be connected via an X2 interface, an Xn interface, or any other interface.

The following aims to address at least one of the above-mentioned issues.

To address at least one of the above-mentioned issues, the present application proposes a proactive transfer of UE context, such that the UE context is available in at least one satellite (e.g., an access node/eNB) before that satellite provides coverage to the UE. In particular, the UE context may be pushed to the relevant eNB(s) in advance instead of being fetched in response to a UE request to resume an RRC connection, as per the case in FIG. 6. The pushing of UE context may be dependent on the predictable movement of satellites in NTN.

It is understood that there are existing mechanisms for a gNB to proactively transfer the UE context to one or more gNBs based on UE assistance information (for example, in dependence on radio resource management (RRM) measurements, UE mobility state, best neighbors) and a network implementation algorithm (e.g. based on RSRP targets)). However, these known mechanisms do not consider non-terrestrial network scenarios, where the serving eNB changes due to satellite movement, and do not consider potential lack of connectivity between an access point and other access points/core network entities. The present disclosure addresses this.

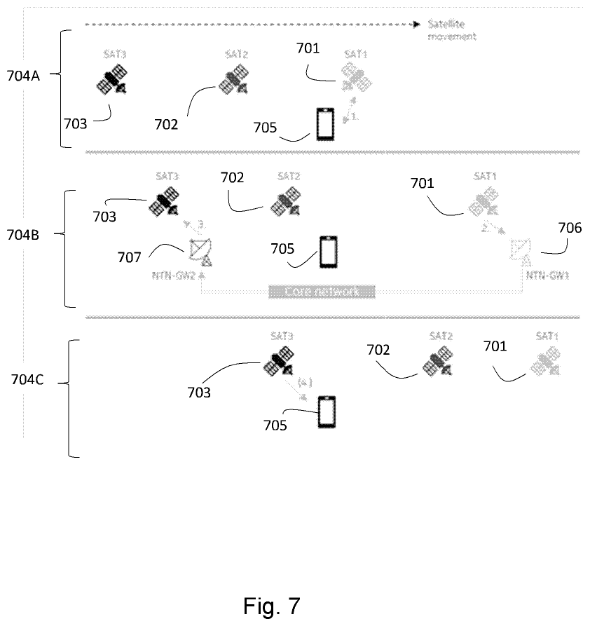

The present disclosure is illustrated with respect to FIGS. 7 to 12.

FIG. 7 illustrates the relative locations of a first satellite 701, a second satellite 702 and a third satellite 703 during a first time 704A, a second time 704B, and a third time 704C. A UE 705 is illustrated as being stationary during times 704A-C, although it understood that the UE 705 may move. The second time 704B also shows a first NG gateway 706 and a second NG gateway 707.

During the first time 704A, the first satellite 701 acts as a first access node to the UE 705 as it is the closest access node.

During the second time 704B, the first satellite 701 determines that the third satellite 703 will shortly be approaching the UE 705 for serving the UE 705, and so causes UE context for the UE 705 to be pushed to the third satellite 703 via the first and second gateways 706, 707.

During the third time 704C, the UE 705 is served by the third satellite 703 using the pushed UE context. Although not shown, the second satellite 702 may provide coverage/core network connection to the UE 705 without receiving the UE context.

In the example of FIG. 7, the UE context may be created in serving eNB on the first satellite 701 before a Radio Resource Control connection between the eNB and the core network is suspended (e.g., because SAT1 is moving away). The decision to suspend the RRC connection may be based on a determination that a future satellite (e.g., the third satellite 703) may have feedback to provide to the UE (e.g., when the UE has sent uplink data via the first satellite 701), and/or a determination that the UE 705 has indicated that it has data to transmit uplink (i.e., the UE has indicated that the UE has a non-zero buffer status) while there is insufficient time to perform the data transfer prior the first satellite 701 moving out of range of the UE 705, and/or when the first satellite determines that, according to the UE's traffic pattern, the UE 705 is likely to transmit and/or receive data at a predictable point in time.

Further, FIG. 7 illustrates that the access node/eNB of the first satellite transfers UE context to the core network. This means that the UE context may not be located in the eNB (satellite), but on Earth when the first satellite 701 has its connectivity to a core network/gateway located on the ground.

An MME or some other core network node (e.g., an NTN specific database) may be working as a proxy for a gateway, and may therefore store the UE context received from the first satellite.

Alternatively, the UE context may be stored at an NTN-GW (e.g., as a type of X2 proxy).

With respect to this, it is noted that, in most 3GPP discussions, an NTN gateway is considered to be a transport node, which does not impact the 3GPP communication. This is similar to an Internet Protocol (IP) router. However, it may be beneficial to instead treat NTN gateways as apparatus that can store some information instead of only routing it onwards to another location. The presently described NRN gateway may therefore store X2 information (i.e. information relating to the interface between two eNBs) such that information from a first access point/eNB of the first satellite is temporarily stored in the NTN-gateway and then pushed to the second access point/eNB of the second satellite when the NTN-GW serves that second access point. This would avoid the routing/storing in another core network node, which saves network resources.

The access node/eNB of the first satellite 701 may indicate the target satellite(s) (using, for example, a satellite identifier and/or an access node identifier) based on knowledge of UE location, satellite ephemeris/access node trajectory and/or velocity, NTN-gateway locations, and/or the characteristics of the expected traffic. Therefore, in the present example, the first satellite 701 may comprise an identifier of the third satellite 703 and/or an access node comprised therein in signalling to the core network when providing the UE context to the core network.

The UE context may additionally comprise the UE's last known location (or information related thereto) and/or an indication of the UE's trajectory. The UE's last known location may be indicated using, for example, information provided from a global navigation satellite system (GNSS) and/or a mapped cell ID. As an aside, it is noted that 3GPP has recently agreed that cell IDs may be mapped to a specific location on Earth independently of how radio coverage moves on Earth with a satellite's movement.

Further, in the example of FIG. 7, the receiving core network proxy node transfers UE context to at least one relevant satellite/access node (the third satellite in the present example).

The target satellite(s)/access node(s) may be identified based on UE location (and/or UE trajectory), satellite ephemeris/access node trajectory and/or velocity, and/or NTN-GW locations.

The target (third) satellite 703 may be identified as being a first relevant satellite. A relevant satellite is considered herein as being a satellite that is expected to have core network connectivity after the first satellite has lost core network connectivity, and that will provide coverage to the area of the UE after the first satellite no longer provides a coverage area that encompasses the UE 705. As mentioned above, the relevant satellite may be identified in response to determining that the UE 705 has non-zero buffers status, and/or there is feedback/downlink data for the UE in the core network, and/or there is traffic expected for or from the UE 705 based on the UE's traffic pattern.

In one example, the UE context is always transferred to future satellites (and/or access nodes located therein) that are determined as covering a coverage area (e.g., a tracking area or a larger area) of the UE.

Further, a selected subset of satellites (eNBs) may be configured to receive the UE context with a “time to drop context”-parameter set by the core network. On receipt of the “time to drop context” parameter, a satellite starts a timer using a value associated with said parameter. When the timer expires (at a time proportional to said value), the receiving satellite deletes the UE context from the receiving satellite.

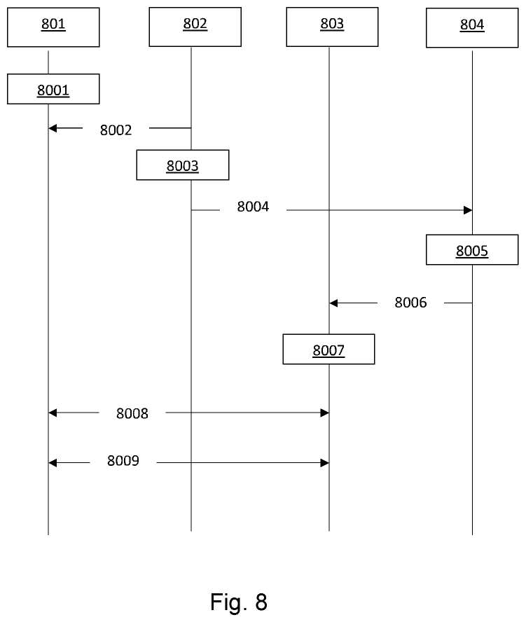

The relevant satellite/access node (e.g., the third satellite in the present example) subsequently uses the UE context when communicating with the UE 705. This process is further illustrated with respect to FIG. 8.

FIG. 8 is a signalling diagram illustrating example signalling between a UE 801, the first satellite 802, the third satellite 803, and a core network 804. This signalling may reflect signaling performed in the example of FIG. 7. Each of the first and third satellites has at least one access point/eNB onboard, and in the following a reference to a satellite entails a reference to the at least one onboard access point/eNB.

During 8001, the UE 801 is expected to transmit and/or receive data at a future point in time at which the first satellite 802 is not expected to be connected to the core network 804 and/or the first satellite 802 is expected to be outside of signalling range of the UE 801. The UE may be expected to transmit and/or receive data at a future point in time when, for example, the UE may comprise at least one packet in its uplink buffer, and/or expect downlink data (such as, for example, feedback to previously transmitted data), and/or the UE may have a traffic pattern that indicates data is expected to be transmitted and/or received.

This expectation of 8001 may be determined by the UE 801 and/or by the first satellite 802.

During 8002, the first satellite 802 signals the UE 801. This signalling of 8002 may be an instruction to the UE to suspend an RRC connection previously established between the UE 801 and the first satellite 802.

During 8003, the first satellite 802 stores the UE context associated with UE 801.

During 8004, the first satellite 802 signals the core network 804. This signalling of 8004 may provide the core network 803 with the UE context.

During 8005, the core network 804 determines that the third satellite 803 with be able to serve the UE 801 at said future point in time, and consequently determines to provide the third satellite 803 with the UE context.

In response to the determination of 8005, the core network 804 forwards the UE context received during 8004 to the third satellite 803 during 8006.

During 8007, the third satellite 803 stores the UE context received during 8006.

During 8008, the UE 801 and the third satellite exchange signalling for resuming the suspending RRC connection using the UE context.

During 8009, the UE 801 and the third satellite 803 exchange uplink and/or downlink signalling for later communication to the core network 804.

In this example of FIG. 8, the first satellite 802 determines to suspend an RRC Connection currently active between the UE 801 and the first satellite 802. The first satellite, subsequent to this determination, forwards the UE context to an entity in the core network. The entity in the core network may subsequent determine that the third satellite 803 is likely to be able to use the UE context for facilitating communications between the UE 801 and the core network via the third satellite 803, and provides the third satellite with the UE context. When the third satellite has received the UE context, the third satellite is able to accept a request from the UE 801 to resume the RRC connection. When the RRC connection has been resumed, data transfer between the UE 801 and the core network via the third satellite 803 may commence.

In a slight variation to the above example, the UE context may be stored in a non-core network entity. For example, the UE context may be stored in a third party network, and/or in a radio access network node. For example, the first satellite may forward the UE context to a proxy node and/or a database node instead of to a core network node, such as in the above example of FIG. 8.

In one example, the proxy node may be a Radio Access Node in a geostationary satellite. In this example, the first satellite may forward UE context procedure using an X2AP procedure, where an “X2AP procedure” refers to a procedure that uses direct signalling between two radio access network nodes. This may be different to current X2AP Retrieve UE context procedure that is performed by a serving network access node to retrieve the UE context from the old network access node as an intermediary radio access network entity stores the UE context, the intermediary radio access network entity not using the UE context for facilitating communication between the UE and the core network.

As an alternative to using direct signaling between two radio access network nodes respectively located in a geostationary satellite and a non-geostationary satellite (i.e., a low earth orbit satellite), the communication between two satellites may be effected using a satellite-based communication link (i.e., non-3GPP-based communication).

As another example, the proxy node may be a database node that is configured to provide a service-based interface, e.g. in 6G (or beyond) architecture.

In any of the above examples, the RRC suspend message may comprise an indication of a next entity that will carry the UE context and/or a time at which the UE context is available in other satellites. When a time is provided, this time may define when the UE is first allowed to attempt to resume the RRC Connection. The timing and/or identifier of the network node may be provided together with a new release cause, such as, for example, “resume_store_forward”. The new release cause may be considered to function as an indicator that another satellite will be able to resume the RRC connection.

In all of the above examples, the first satellite may receive a list of satellites (e.g., satellite #3, satellite #4, satellite #5) respectively associated with times at which those satellites may comprise the UE context. For example, the first satellite may receive the list of satellites combined with an indication that satellite #3 will provide coverage in the area X at time T1, satellite #4 will provide coverage in area X at time T2, and satellite #5 will provide coverage in the area X at time T3. This information may be received from an entity in the core network. Although the areas are indicated as being the same, it is understood that this is not limiting, and that the network may indicate areas independently for each satellite-time combination. This may be usefully applied when the network determines a likely future location of the UE based on the UE's current trajectory. Providing the first satellite with such a list may enable the first satellite to also provide this information to the UE without the first satellite having to perform its own estimations.

The AS security between a UE and a radio access node may rely on at least three different security keys (labelled herein as KRRCint, KRRCenc, KUPenc), which are all derived from a key associated with that radio access node. This associated key will herein be labelled as a KeNB key. The four keys may change upon every RRC connection resume performed, where the UE derives a new KeNB key using a predetermined parameter. In current 3GPP specifications, this parameter is labelled as the “nextHopChainingCount” parameter (see, for example, 3GPP TS 36.331 and 3GPP TS 33.401).

When the RRC connection is suspended, the UE will store a value of the nextHopChainingCount parameter that has been provided by the network. When the UE prepares to transmit the RRC Connection Resume Request message to the target eNB, the UE will utilize the nextHopChainingCount parameter to derive a new KeNB Key and related keys for AS security. The UE will subsequently use these keys for configuring its lower layers to resume integrity protection and ciphering when communicating upstream. Upon reception of an RRC Connection Resume message from a target satellite that comprises a new value for the nextHopChainingCount parameter, the UE may update the current KeNB to a new KeNB (along with any associated keys) to reflect the change in value of the nextHopChainingCount parameter.

As mentioned above, the UE may communicate with the core network using multiple different satellites (and thus eNBs) at different times. The UE may thus update a value of KeNB as it switches from one target eNB (on a satellite) to another target eNB (on another satellite). To ensure that the UE uses the correct set of security keys in this situation, the serving access node (i.e., the access node at where the UE context is originally generated) may provide the UE with multiple nextHopChainingCount values for generating multiple target KeNB values to respective target satellites. Such a system may enable the set of target eNBs to communicate with the UE even when it has changed the KeNB key.

The presently described system may advantageously maintain UE context including in the store and forward scenarios, which may result in a simpler connection establishment procedure when a new satellite provides coverage to the UE. Further, transferring the UE context to a proxy on Earth may enable a proactive push of UE context to the relevant satellites in time (i.e., when the relevant satellites still have core network connectivity).

As an aside, the above uses eNBs/LTE as examples to showcase the presently described principles. However, it is understood that other RAN nodes (such as, for example, gNBs) may also apply the presently described principles in the same way as the eNBS mentioned herein. Examples described in relation to eNBs may therefore be considered as not being limited to eNBs.

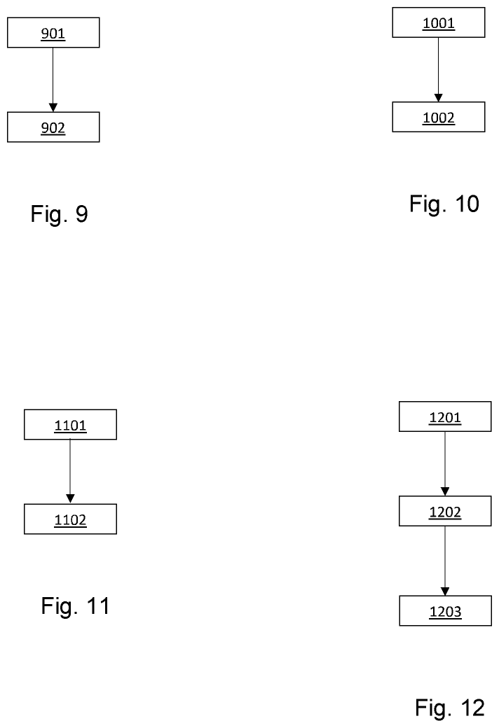

FIGS. 9 to 12 illustrate aspects of the above examples. It is therefore understood that features described above in relation to the previous examples may be implemented in the following aspects. It is understood that although the terms geostationary and non-geostationary are used throughout in relation to various apparatus, that these terms do not mandate that those apparatus are located on or in a satellite/satellite orbit. For example, a geostationary apparatus may be considered to be an apparatus that maintains a fixed displacement with respect to a fixed location on Earth, while a non-geostationary apparatus may be considered to be an apparatus that varies its displacement with respect to a fixed location on Earth. For example, the geostationary apparatus can be considered as static base station and/or access node, and the non-geostationary apparatus may be considered as a moving base station and/or access node regardless of whether those are mounted on or in a satellite.

FIG. 9 illustrates operations that may be performed by an apparatus for a non-geostationary first access node. The non-geostationary access node may be configured to provide a service/service provision area to a user equipment while the user equipment is located in that service/service provision area. The service/service provision area may correspond to a coverage area defined by at least one cell provided by that non-geostationary first access node. The non-geostationary first access node may interact with the apparatus of any of FIGS. 10 to 12.

During 901, the apparatus determines to suspend a radio resource control connection between the non-geostationary first access node and the user equipment, wherein the radio resource control connection is defined by a user context. The user context may be a radio access context. By this, it is meant that the user context may define at least one set of parameters for enabling the user equipment to access a network via an access node (e.g., via the first access node).

During 902, the apparatus provides the user context to a first proxy node with an indication that the user context is to be stored for retrieval by a non-geostationary second access node.

The determining to suspend a radio resource control connection between the non-geostationary first access node and the user equipment may comprise at least one of the following.

First, the apparatus may determine that the user equipment is likely to receive feedback to previously transmitted uplink data within a first time period and that the non-geostationary first access node will not be providing a service connectivity to the user equipment for at least part of the first time period.

Second, the apparatus may determine that the user equipment has uplink data to transmit during a second time period and that the non-geostationary first access node will not be providing a service connectivity to the user equipment for at least part of the second time period.

Third, the apparatus may determine, based on a traffic pattern associated with the user equipment, that the user equipment is likely to transmit and/or receive data during a third predetermined time period and that the non-geostationary first access node will not be providing a service connectivity to the user equipment for at least part of the third time period.

When any of the first to third are positively determined, the apparatus may determine to suspend the radio resource control connection.

The apparatus may identify the non-geostationary second access node and/or an apparatus comprising the non-geostationary second access node; and provide an indication of the non-geostationary second access node and/or the apparatus comprising the non-geostationary second access node to the first proxy node. The apparatus comprising the non-geostationary second access node may comprise, for example, a satellite and/or a vehicle.

The apparatus may identify the non-geostationary second access node and/or the apparatus comprising the non-geostationary second access node by identifying the non-geostationary second access node and/or the apparatus comprising the non-geostationary second access node based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

FIG. 10 illustrates operations that may be performed by an apparatus for a first proxy node. The first proxy node may be as described above in relation to FIG. 9. The first proxy node may interact with the apparatus of any of FIGS. 9, 11, and/or 12.

During 1001, the apparatus receives, from a non-geostationary first access node, a user context that defines a radio resource control connection between the non-geostationary first access node and a user equipment, and an indication that the user context is to be provided to a non-geostationary second access node.

During 1002, the apparatus causes the user context to be provided to the non-geostationary second access node.

The causing the user context to be provided to a non-geostationary second access node may comprise providing the user context to a second proxy node with an indication that the user context is to be provided to the non-geostationary second access node.

The causing the user context to be provided to a non-geostationary second access node may comprise providing the user context directly to the non-geostationary second access node. In other words, the first proxy node may signal the user context to the non-geostationary node without it passing through an intermediary node.

The apparatus may receive an identifier of the non-geostationary second access node from the non-geostationary first access node.

The apparatus may receive the identifier of the non-geostationary second access node as part of receiving a set of identifiers identifying respective access nodes.

The apparatus may provide the user context to at least two of said respective access nodes. The non-geostationary second access node may be one of said at least two of said respective access nodes. The apparatus may provide the user context to all of said respective access nodes.

The apparatus may identify the non-geostationary second access node using at least one of: a current location of the user equipment, a tracking area and/or cell associated with the user equipment, a trajectory of the user equipment, the non-geostationary second access node's ephemeris, the non-geostationary second access node's trajectory and/or velocity, locations of ground-based gateways to a core network, and/or characteristics of traffic to be transmitted and/or received by the user equipment.

The causing the user context to be provided to the non-geostationary second access node may comprise causing the user context to be provided to the non-geostationary second access node with an indication of at a time at which the user context is to be deleted by the non-geostationary second access node. The non-geostationary second access node may delete the user context from the non-geostationary second access node when said indicated time is reached.

When the user context is provided to a plurality of access nodes (e.g., at least two and/or all of the respective access nodes discussed above), each of said plurality of access nodes may be provided with respective times indicating at which time the user context is to be deleted by that access node. Each of said plurality of access nodes may be configured to delete the user context when their respective times are reached. The respective times may be different to each other.

FIG. 11 illustrates operations that may be performed by an apparatus for a non-geostationary second access node. The non-geostationary second access node may interact with the apparatus of any of FIGS. 9, 10, and/or 12.

During 1101, the apparatus receives, from a first and/or second proxy node, a user context that defines a radio resource control connection between a non-geostationary first access node and a user equipment.

During 1102, the apparatus resumes a radio resource control connection procedure between the user equipment and the non-geostationary second access node using the user context.

The resuming a radio resource control connection procedure may comprise the following. The apparatus may receive, from the first and/or second proxy node, an indication of a count value. The apparatus may use the count value to generate a plurality of keys for encrypting communications between the non-geostationary second access node and the user equipment. The apparatus may use the plurality of keys for encrypting communications between the non-geostationary second access node and the user equipment. The encrypted communications may be signalled between the user equipment and the second access node.

The resuming a radio resource control connection procedure may comprise performing said resuming in response to: signalling, to the user equipment, a trigger in a paging signal for causing the user equipment to initiate the resume radio resource control procedure.

The resuming a radio resource control connection procedure may comprise r performing said resuming in response to: receiving, from a user equipment an instruction to initiate the resume radio resource control procedure when the user context defines that the user equipment is configured to initiate the resume radio resource control procedure.

FIG. 12 illustrates operations that may be performed by an apparatus for a user equipment. The user equipment may interact with the apparatus of any of FIGS. 9, 10, and/or 11.

At 1201, the apparatus establishes a radio resource control connection with a non-geostationary first access node, the radio resource control connection being defined by a user context.

At 1202, the apparatus suspends the radio resource control connection using a suspend radio resource control connection procedure.

At 1203, the apparatus resumes the radio resource control connection with a non-geostationary second access node using the user context.

The resuming the radio resource control connection may comprise: receiving, from a first and/or second proxy node, an indication of a count value; using the count value to generate a plurality of keys for encrypting communications between the non-geostationary second access node and the user equipment; and using the plurality of keys for encrypting communications between the non-geostationary second access node and the user equipment. The encrypted communications may be transmitted from the user equipment to the non-geostationary second access node.

The resuming a radio resource control connection procedure may comprise performing said resuming in response to determining, from the user context that the user equipment is configured to initiate the resume radio resource control procedure.

The resuming a radio resource control connection procedure may comprise: retrieving, from the user context, an indication of a count value; using the count value to generate a plurality of keys for encrypting communications between the non-geostationary second access node and the user equipment; and using the plurality of keys for encrypting communications between the non-geostationary second access node and the user equipment.

The resuming a radio resource control connection procedure may comprise performing said resuming in response to: receiving, from the non-geostationary second access node, a trigger in a paging signal for causing the user equipment to initiate the resume radio resource control procedure.

In all of the above examples of FIGS. 9 to 12, the wherein the first and/or second proxy node may be at least one of: an access and mobility management function, a ground-based gateway to a core network, a database located in a core network, and/or a Mobility Management Entity.

Further, in all of the above examples of FIGS. 9 to 12, the user context may comprise at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.

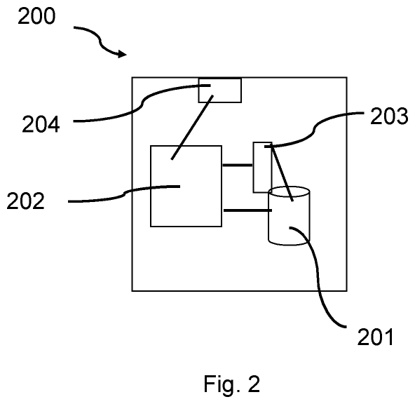

FIG. 2 shows an example of a control apparatus for a communication system, for example to be coupled to and/or for controlling a station of an access system, such as a RAN node, e.g. a base station, gNB, eNB, access node (AN), access point (AP), a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. These terms for a station of an access system/control apparatus will be used interchangeably. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions.

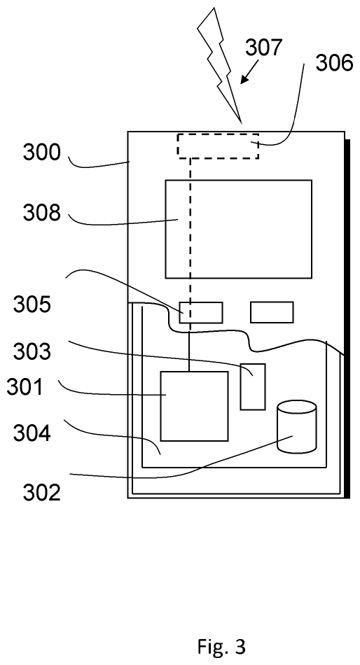

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), a vehicle, a UE mounted in or on a vehicle, a personal data assistant (PDA), and/or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or′ wireless) to other devices and/or for connecting external accessories, for example hands-free equipment, thereto.

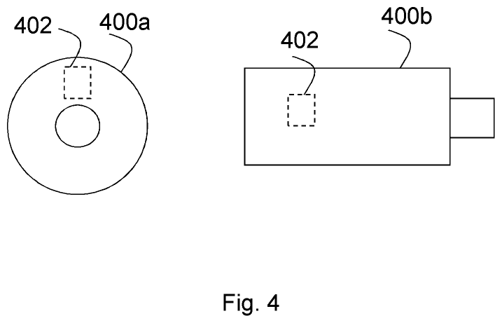

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 9, and/or FIG. 10, and/or FIG. 11, and/or FIG. 12, and/or methods otherwise described previously.

As provided herein, various aspects are described in the detailed description of examples and in the claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIG. 9, and/or FIG. 10, and/or FIG. 11 and/or FIG. 12, and/or otherwise described previously, may represent program steps, or interconnected logic circuits, blocks and functions, or a combination of program steps and logic circuits, blocks and functions. The software may be stored on such physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

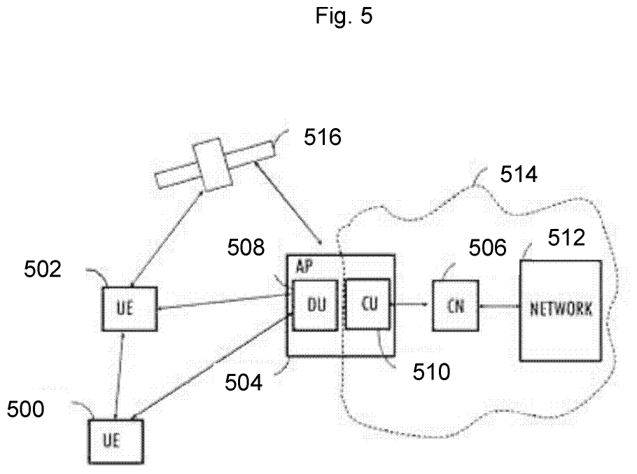

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g) NodeB serving devices in a cell. In one example, the node 504 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 506 (CN or next generation core NGC). Depending on the deployed technology, the (e/g) NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHZ-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The LTE network architecture is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). This may also be referred to as Edge computing when performed away from the core network. The communication system may also comprise a central control entity, or a like, providing facilities for networks of different operators to cooperate for example in spectrum sharing.

The technology of Edge computing may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where Edge computing servers can be placed between the core and the base station or nodeB (gNB). One example of Edge computing is MEC, which is defined by the European Telecommunications Standards Institute. It should be appreciated that MEC (and other Edge computing protocols) can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service for critical availability communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The depicted system is only an example of a part of a radio access system and in practice, the system may comprise a plurality of (e/g) NodeBs, the device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 5 may provide any kind of these cells. A cellular radio system may be implemented as a multilayer network including several kinds of cells. Typically, in multilayer networks, one access node.

1.-32. (canceled)

33. An apparatus for a non-geostationary first access node, the apparatus comprising at least one processor; and at least one memory comprising code that, when executed by the at least one processor causes the apparatus to perform:
determining to suspend a radio resource control connection between the non-geostationary first access node and a user equipment, wherein the radio resource control connection is defined by a user context; and
providing the user context to a first proxy node with an indication that the user context is to be stored for retrieval by a non-geostationary second access node.

34. The apparatus as claimed in claim 33, wherein the determining comprises at least one of the following:
determining that the user equipment is likely to receive feedback to previously transmitted uplink data within a first time period and that the non-geostationary first access node will not be providing a service connectivity to the user equipment for at least part of the first time period;
determining that the user equipment has uplink data to transmit during a second time period and that the non-geostationary first access node will not be providing a service connectivity to the user equipment for at least part of the second time period; or
determining, based on a traffic pattern associated with the user equipment, that the user equipment is likely to transmit and/or receive data during a third predetermined time period and that the non-geostationary first access node will not be providing a service connectivity to the user equipment for at least part of the third time period.

35. The apparatus as claimed in claim 33, wherein the apparatus is further caused to perform:
identifying the non-geostationary second access node and/or an apparatus comprising the non-geostationary second access node; and
providing an indication of the non-geostationary second access node and/or the apparatus comprising the non-geostationary second access node to the first proxy node.

36. The apparatus as claimed in claim 35, wherein the identifying is based on at least one of: a current location of the user equipment, a trajectory of the user equipment, the non-geostationary first access node's ephemeris, the non-geostationary second access node's ephemeris, the non-geostationary first access node's trajectory and/or velocity, the non-geostationary second access node's trajectory and/or velocity, locations of ground-based gateways to a core network, a tracking and/or registration area associated with the user equipment, and/or characteristics of traffic to be transmitted and/or received by the user equipment.

37. The apparatus as claimed in claim 33, wherein the apparatus is further caused to perform providing an identifier of the non-geostationary second access node to the first proxy node.

38. The apparatus as claimed in claim 37, wherein the apparatus is further caused to perform providing the identifier of the non-geostationary second access node as part of providing a set of identifiers identifying respective access nodes.

39. An apparatus for a non-geostationary second access node, the apparatus comprising at least one processor; and at least one memory comprising code that, when executed by the at least one processor causes the apparatus to perform:
receiving, from a first and/or second proxy node, a user context that defines a radio resource control connection between a non-geostationary first access node and a user equipment; and
resuming a radio resource control connection procedure between the user equipment and the non-geostationary second access node using the user context.

40. The apparatus as claimed in claim 39, wherein resuming the radio resource control connection procedure comprises:
receiving, from the first and/or second proxy node, an indication of a count value;
using the count value to generate a plurality of keys for encrypting communications between the non-geostationary second access node and the user equipment; and
using the plurality of keys for encrypting communications between the non-geostationary second access node and the user equipment.

41. The apparatus as claimed in claim 39, wherein resuming the radio resource control connection procedure comprises performing said resuming in response to:
signalling, to the user equipment, a trigger in a paging signal for causing the user equipment to initiate the resume radio resource control procedure.

42. The apparatus as claimed in claim 39, wherein resuming the radio resource control connection procedure comprises performing said resuming in response to:
receiving, from a user equipment an instruction to initiate the resume radio resource control procedure when the user context defines that the user equipment is configured to initiate the resume radio resource control procedure.

43. The apparatus as claimed in claim 39, wherein at least one of the first or second proxy node is at least one of: a ground-based gateway to a core network, a database located in a core network, or a Mobility Management Entity.

44. An apparatus for a user equipment, the apparatus comprising at least one processor; and at least one memory comprising code that, when executed by the at least one processor causes the apparatus to perform:
establishing a radio resource control connection with a non-geostationary first access node, the radio resource control connection being defined by a user context;
suspending the radio resource control connection using a suspend radio resource control connection procedure;
resuming the radio resource control connection with a non-geostationary second access node using the user context.

45. The apparatus as claimed in claim 44, wherein resuming the radio resource control connection comprises:
receiving, from a first and/or second proxy node, an indication of a count value;
using the count value to generate a plurality of keys for encrypting communications between the non-geostationary second access node and the user equipment; and
using the plurality of keys for encrypting communications between the non-geostationary second access node and the user equipment.

46. The apparatus as claimed in claim 44, wherein resuming the radio resource control connection procedure comprises performing said resuming in response to:
determining, from the user context that the user equipment is configured to initiate the resume radio resource control procedure.

47. The apparatus as claimed in claim 44, wherein resuming the radio resource control connection procedure comprises:
retrieving, from the user context, an indication of a count value;
using the count value to generate a plurality of keys for encrypting communications between the non-geostationary second access node and the user equipment; and
using the plurality of keys for encrypting communications between the non-geostationary second access node and the user equipment.

48. The apparatus as claimed in claim 44, wherein resuming the radio resource control connection procedure comprises performing said resuming in response to:
receiving, from the non-geostationary second access node, a trigger in a paging signal for causing the user equipment to initiate the resume radio resource control procedure.

49. The apparatus as claimed in claim 44, wherein the user context comprises at least one of: a known location of the user equipment, information associated with a radio resource control configuration of the user equipment, information associated with access stratum security of a connection between the user equipment and an access network, a trajectory of the user equipment, and/or an identifier of a cell within which the user equipment is operating.
